(19) United States
(12) Patent Application Publication
(10) Pub. No.: US 2006/0111987 A1
(43) Pub. Date: May 25, 2006

(54) Personalized combo kit of tools and accessories

(76) Inventors: David Robert Johnston, Jackson, TN (US); Alan Phillips, Jackson, TN (US)

Correspondence Address: THE BLACK & DECKER CORPORATION, 701 EAST JOPPA ROAD, TW199, TOWSON, MD, 21286, US

(21) Appl. No.: 11/063,654

(22) Filed: Feb. 22, 2005

Related U.S. Application Data
(60) Provisional application No. 60/546,684, filed on Feb. 20, 2004.

(51) Int. Cl. G06Q 30/00

(52) U.S. Cl. 705/26

(57) ABSTRACT

The present invention provides a method for providing a personalized combo kit of tools and accessories. A plurality of tools and accessories are provided to a customer for selection. The customer is enabled to select at least two items from the plurality of tools and accessories. The selected at least two items are offered to the customer at a discount price.

### CROSS-REFERENCE TO RELATED DOCUMENTS

The present application claims the benefit under 35 U.S.C. § 119(e) of U.S. Provisional Application Ser. No. 60/546,684, filed Feb. 20, 2004, which is herein incorporated by reference in its entirety.

### FIELD OF THE INVENTION

The present invention relates generally to tools and their accessories and particularly to a method for providing and/or selling a personalized combo kit of tools and their accessories.

### BACKGROUND OF THE INVENTION

Tools and their accessories are often sold as fixed, pre-configured combo kits at a discounted price. For example, a fixed cordless drill combo kit may be sold as a combination of components such as a drill, a battery charger and two batteries. Such a concept of a fixed combo kit is beneficial to the customer because the customer pays less than the customer would if the customer buys each component separately and is also beneficial to the manufacturer/distributor because the manufacturer/distributor can sell more products at one time than the manufacture/distributor would if the manufacturer/distributor sells each component separately.

However, this concept of a fixed combo kit still has some shortcomings. For example, in the foregoing described example, after a customer buys the fixed cordless drill combo kit, later the customer may decide that the customer needs to buy a spare battery for the drill, a cordless reciprocal saw, and a circular saw. Under the conventional fixed combo kit concept, the customer either has to buy a second fixed cordless drill combo kit including unneeded drill and battery charger, or has to buy the saws and the battery at the non-discounted prices.

Thus, it is desirable to provide a flexible, personalized combo kit, which may allow the customer to have more selections of components within a combo kit at discounted pricing, and may allow the manufacturer/distributor to carry a lower inventory and to better forecast the customer demand, therefore reducing the cost for the manufacturer.

### SUMMARY OF THE INVENTION

According to one exemplary aspect of the present invention, a method for providing a personalized combo kit of tools and accessories includes the following steps. A plurality of tools and accessories are provided to a customer for selection. The customer is enabled to select at least two items from the plurality of tools and accessories. The selected at least two items are offered to the customer at a discount price.

cording to an additional exemplary aspect of the present invention, a method for providing a personalized combo kit of tools and accessories online includes the following steps. A plurality of tools and accessories are provided to a customer for selection via the Internet. The customer is enabled to select at least two items from the plurality of tools and accessories via the Internet. The selected at least two items are offered to the customer at a discount price via the Internet.

According to another exemplary aspect of the present invention, a computer-readable medium having computer-executable instructions for performing a method of providing a personalized combo kit of tools and accessories is provided. The method includes the following steps. A plurality of tools and accessories are provided to a customer for selection. The customer is enabled to select at least two items from the plurality of tools and accessories. The selected at least two items are offered to the customer at a discount price.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flowchart of an exemplary method for providing a personalized combo kit of tools and accessories in accordance with an exemplary embodiment of the present invention; and

FIG. 2 is a flowchart of an exemplary method for providing a personalized combo kit of tools and accessories online in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

The present invention may enable the customer to create a variety of tool and accessories combinations for purchase, which may meet the customer's specific needs. In one embodiment, at a point of sale such as a store, shop, online store (e.g., through the Internet), or the like, the customer is provided with a choice for personalizing a combo kit of tools and accessories. The customer may select, mix, and match products to create its own personalized combo kit with corresponding discounted pricing. In another embodiment, an online customer may be able to select from a broad range of tools and/or accessories to create a unique combination tool kit. By allowing the customer to select from a variety of tools and related accessories, the customer may personalize or customize the tool set for specific professions and/or jobsite requirements. For example, an installer of kitchen cabinets may elect to combine two cordless drills, three batteries, and a charger with a carrying case, while a plumber may configure his/her kit with a hammerdrill, two batteries, and a reciprocal saw with no carrying case. The personalization or customization process may be greatly enhanced via the Internet due to no restrictions on the retail space, no merchandising components, and the prevailing shopping behavior at online stores where customers pick and choose to add items to the online shopping cart.

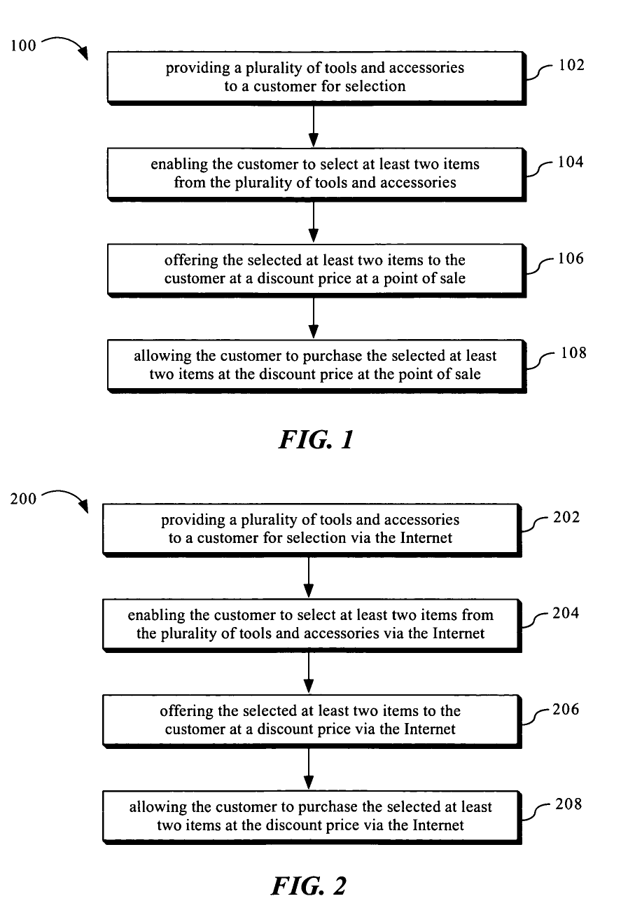

Now referring to FIG. 1, a flowchart of an exemplary method 1 00 for providing a personalized combo kit of tools and accessories in accordance with an exemplary embodiment of the present invention is shown. A plurality of tools and accessories are provided to a customer for selection 102. The plurality of tools and accessories may be selected from cordless tools, power tools, air compressors, air tools, pressure washers, and related accessories, and the like. Preferably, the plurality of tools and accessories include a base kit. A base kit may be tools only, accessories only, or a combination of tool and accessory. For example, a base kit may include two batteries, a charger and a carrying case (or bag). The customer is enabled to select at least two items from the plurality of tools and accessories 104. Preferably, the selected items include the base kit. The selected items are offered to the customer at a discount price at a point of sale such as a store, shop, online store (e.g., via the Internet, Intranet, etc.), or the like 106. The customer is allowed to purchase the selected items at the discount price at the point of sale 108.

FIG. 2 is a flowchart of an exemplary method 200 for providing a personalized combo kit of tools and accessories online in accordance with an exemplary embodiment of the present invention. A plurality of tools and accessories are provided to a customer for selection via the Internet 202. The plurality of tools and accessories may be selected from cordless tools, power tools, air compressors, air tools, pressure washers, and related accessories, and the like. Preferably, the plurality of tools and accessories include a base kit. A base kit may be tools only, accessories only, or a combination of tool and accessory. For example, a base kit may include two batteries, a charger and a carrying case (or bag). The customer is enabled to select at least two items from the plurality of tools and accessories via the Internet 204. Preferably, the selected items include the base kit. The selected items are offered to the customer at a discount price via the Internet 206. The customer is allowed to purchase the selected items at the discount price via the Internet 208.

It is understood that the present invention may also be applied to any other product in a retail environment, whether online or offline, without departing from the scope and spirit of the present invention.

The present invention may provide the following advantages. First, the manufacture/distributor may be able to carry a lower inventory and better forecast the customer demand, therefore lowering the cost of doing business. Moreover, the customer may be able to have more selections of products with discounted pricing.

It is to be noted that the above described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of software package. Such a software package may be a computer program product which employs a computer-readable medium including stored computer code which is used to program a computer to perform the disclosed function and process of the present invention. The computer-readable medium may include, but is not limited to, any type of conventional floppy disks, optical disks, CD-ROMS, magneto-optical disks, ROMs, RAMs, EPROMs, EEPROMs, magnetic or optical cards, or any other suitable media for storing electronic instructions.

It is understood that the specific order or hierarchy of steps in the processes disclosed is an example of exemplary approaches. Based upon design preferences, it is understood that the specific order or hierarchy of steps in the processes may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for providing a personalized combo kit of tools and accessories, comprising:
providing a plurality of tools and accessories to a customer for selection;
enabling said customer to select at least two items from said plurality of tools and accessories; and
offering said selected at least two items to said customer at a discount price at a point of sale.

2. The method of claim 1, wherein said plurality of tools and accessories include a base kit.

3. The method of claim 2, wherein said selected at least two items include said base kit.

4. The method of claim 1, wherein said plurality of tools and accessories include at least one of a cordless tool, a compressor, an air tool, a power tool, or a pressure washer.

5. The method of claim 1, wherein said point of sale is an online store.

6. The method of claim 1, wherein said point of sale is a store.

7. The method of claim 1, further comprises allowing said customer to purchase said selected at least two items at said discount price at said point of sale.

8. A method for providing a personalized combo kit of tools and accessories online, comprising:
providing, via Internet, a plurality of tools and accessories to a customer for selection;
enabling said customer to select at least two items from said plurality of tools and accessories via the Internet; and
offering, via the Internet, said selected at least two items to said customer at a discount price.

9. The method of claim 8, wherein said plurality of tools and accessories include a base kit.

10. The method of claim 9, wherein said selected at least two items include said base kit.

11. The method of claim 1, wherein said plurality of tools and accessories include at least one of a cordless tool, a compressor, an air tool, a power tool, or a pressure washer.

12. The method of claim 1, further comprises allowing said customer to purchase said selected at least two items at said discount price via the Internet.

13. A computer-readable medium having computer-executable instructions for performing a method of providing a personalized combo kit of tools and accessories, said method comprising:
providing a plurality of tools and accessories to a customer for selection;
enabling said customer to select at least two items from said plurality of tools and accessories; and
offering said selected at least two items to said customer at a discount price at a point of sale.

14. The computer-readable medium of claim 13, wherein said plurality of tools and accessories include a base kit.

15. The computer-readable medium of claim 14, wherein said selected at least two items include said base kit.

16. The computer-readable medium of claim 13, wherein said plurality of tools and accessories include at least one of a cordless tool, a compressor, an air tool, a power tool, or a pressure washer.

17. The computer-readable medium of claim 13, wherein said point of sale is an online store.

18. The computer-readable medium of claim 13, wherein said point of sale is a store.

19. The computer-readable medium of claim 1, wherein said method further comprises allowing said customer to purchase said selected at least two items at said discount price at said point of sale.
